(19) United States
(12) Patent Application Publication
(10) Pub. No.: US 2007/0020150 A1
(43) Pub. Date: Jan. 25, 2007

(54) Adjustment device for drop dispenser

(76) Inventor: Lawrence J. DaQuino, Los Gatos, CA (US)

Correspondence Address: AGILENT TECHNOLOGIES INC., INTELLECTUAL PROPERTY ADMINISTRATION, M/S DU404, P.O. BOX 7599, LOVELAND, CO, 80537-0599, US

(21) Appl. No.: 11/185,484

(22) Filed: Jul. 20, 2005

(51) Int. Cl. B01L 11/00

(52) U.S. Cl. 422/103

(57) ABSTRACT

The present invention is directed to devices for adjusting a drop dispenser (adjustment devices). Each device consists of two horizontal axis adjusters, one vertical axis adjuster and two rotational axis adjusters wherein the adjusters are integral with a body comprising a base for mounting the device to a drop dispenser. Some embodiments of the invention are directed to a drop-dispensing apparatus comprising at least one module comprising a drop dispenser mounted to a device as described above. Some embodiments of the invention are directed to apparatus for synthesizing arrays of biopolymers on a substrate where the apparatus comprises a dispensing apparatus as mentioned above.

### BACKGROUND

This invention relates in general to drop-dispensing devices. In some embodiments the invention relates to adjustment mechanisms for drop dispensers such as print heads. In some embodiments the invention relates to the manufacture of supports or substrates having bound to the surfaces thereof a plurality of chemical compounds, such as biopolymers.

In the field of diagnostics and therapeutics, it is often useful to attach species to a surface. One important application is in solid phase chemical synthesis wherein initial derivatization of a substrate surface enables synthesis of polymers such as oligonucleotides and peptides on the substrate itself. Substrate bound oligomer arrays, particularly oligonucleotide arrays, may be used in screening studies for determination of binding affinity. Modification of surfaces for use in chemical synthesis has been described. See, for example, U.S. Pat. No. 5,624,711 (Sundberg), U.S. Pat. No. 5,266,222 (Willis) and U.S. Pat. No. 5,137,765 (Farnsworth).

The arrays may be microarrays created on the surface of a substrate by in situ synthesis of biopolymers such as polynucleotides, polypeptides, polysaccharides, etc., and combinations thereof, or by deposition of molecules such as oligonucleotides, cDNA and so forth. In general, arrays are synthesized on a surface of a substrate or substrate by one of any number of synthetic techniques that are known in the art. In one approach, for example, the substrate may be one on which a single array of chemical compounds is synthesized. Alternatively, multiple arrays of chemical compounds may be synthesized on the substrate, which is then diced, i.e., cut, into individual assay devices, which are substrates that each comprises a single array, or in some instances multiple arrays, on a surface of the substrate.

The in situ synthesis methods include those described in U.S. Pat. No. 5,449,754 for synthesizing peptide arrays, as well as WO 98/41531 and the references cited therein for synthesizing polynucleotides (specifically, DNA). Such in situ synthesis methods can be basically regarded as repeating at each spot the sequence of: (a) deprotecting any previously deposited monomer so that it can now link with a subsequently deposited protected monomer; and (b) depositing a droplet of another protected monomer for linking. Different monomers may be deposited at different regions on the substrate during any one iteration so that the different regions of the completed array will have different desired biopolymer sequences. One or more intermediate further steps may be required in each iteration, such as oxidation, capping and washing steps. The deposition methods basically involve depositing biopolymers at predetermined locations on a substrate, which are suitably activated such that the biopolymers can link thereto. Biopolymers of different sequence may be deposited at different regions of the substrate to yield the completed array. Washing or other additional steps may also be used. Reagents used in typical in situ synthesis are water sensitive, and thus the presence of moisture should be eliminated or at least minimized.

Similar technologies can be used for in situ synthesis of biopolymer arrays, such as DNA oligomer arrays, on a solid substrate. In this case, each oligomer is formed nucleotide by nucleotide directly in the desired location on the substrate surface. This process demands repeatable drop size and accurate placement on the substrate.

As indicated above, one of the steps in the synthesis process usually involves depositing small volumes or microdroplets of liquid containing reagents for the synthesis, for example, monomeric subunits or whole polynucleotides, onto to a surface of a support or substrate. In one approach, pulse-jet techniques are employed in depositing small volumes of liquid for synthesis of chemical compounds on the surface of substrates. For example, arrays may be fabricated by depositing droplets from a pulse-jet in accordance with known techniques. Pulse-jets include piezo jets and thermal jets. Given the above requirements of biopolymer array fabrication, deposition using pulse-jet techniques is particularly favorable. In particular, pulse jet deposition has advantages that include producing very small spot sizes. This allows high-density arrays to be fabricated. Furthermore, the spot size is uniform and reproducible. Since it is a non-contact technique, pulse-jet deposition does not result in scratching or damaging the surface of the support on which the arrays are synthesized. Pulse-jet techniques have very high deposition rate, which facilitates rapid manufacture of arrays.

Piezo electric printheads are used in some approaches for delivering reagents when manufacturing in situ arrays. Industrial piezo printheads have a large form factor and a large number of piezo jets. Typically, for preparation of polynucleotide arrays, there is one printhead for each phosphoramidite, one printhead for an activator plus one or more printheads for various other chemical reactants if necessary.

There is a need for an easily adjustable and reliable method of positioning printheads that has application to piezo printheads and the like.

### SUMMARY OF EMBODIMENTS OF THE INVENTION

Some embodiments of the present invention are directed to devices for adjusting a drop dispenser (adjustment devices). Each device consists of two horizontal axis adjusters, one vertical axis adjuster and two rotational axis adjusters wherein the adjusters are integral with a body comprising a base for mounting the device to a drop dispenser. Some embodiments of the invention are directed to a drop-dispensing apparatus comprising at least one module comprising a drop dispenser mounted to a device as described above.

Some embodiments of the invention are directed to drop-dispensing apparatus comprising a device for adjusting a drop dispenser. The device is one as described above. At least one drop dispenser is mounted to the device.

Another embodiment of the invention is a method for adjusting a drop dispenser relative to another drop dispenser and to a surface of a substrate. In the method a drop dispenser is provided attached to an apparatus comprising an adjustment device consisting of an X axis adjuster, a theta about X axis adjuster, a Y axis adjuster, a Z axis adjuster and a theta about Z axis adjuster. The adjusters are manipulated to maintain a dispensing orientation of the drop dispenser.

### BRIEF DESCRIPTION OF THE DRAWINGS

The following figures are included to better illustrate the embodiments of the apparatus and technique of the present invention. The figures are not to scale and some features may be exaggerated for the purpose of illustrating certain aspects or embodiments of the present invention.

FIG. 1 is an illustration of the different directions for each axis adjustment element in embodiments of adjustment devices in accordance with the invention.

FIG. 2 is a schematic view, taken from the side-front, of one embodiment of an adjustment device in accordance with the invention.

FIG. 3 is a schematic view, taken from the bottom-rear, of the embodiment of an adjustment device depicted in FIG. 2.

FIG. 4 is a schematic view depicting the adjustment device of FIG. 2 to which is mounted a drop-dispensing module.

FIG. 5 is a schematic view depicting a portion of the frame of the device of FIGS. 2-3.

FIG. 6 is a schematic view taken from the side depicting the portion of the device shown in FIG. 5.

FIG. 7 is a schematic depiction of an embodiment of an apparatus in accordance with the present invention, which includes an adjustment device as in FIG. 2.

### DESCRIPTION OF SPECIFIC EMBODIMENTS

Before the subject invention is described further, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood to one of ordinary skill in the art to which this invention belongs. Although any methods, devices and materials similar or equivalent to those described herein can be used in the practice or testing of the invention, the preferred methods, devices and materials are now described.

The phrase “adapted to” or “adapted for” is used herein with respect to components of the present apparatus. The components of the present apparatus are adapted to perform a specified function by a combination of hardware and software. This includes the structure of the particular component and may also, and usually does, include a microprocessor, embedded real-time software and I/O interface electronics to control the sequence of operations of the invention.

As mentioned above, the present invention is directed to devices for adjusting a drop dispenser. The device consists of two horizontal axis adjusters, one vertical axis adjuster and two rotational axis adjusters. The adjusters are integral with a body comprising a base for mounting the device to a drop dispenser. The bottom surface of the base is machined to a degree of accuracy that the drop dispensers mount essentially flat in relation to the mounting base.

In using the subject devices, a drop dispenser present in the adjuster is loaded with a volume of fluid, which in many embodiments is a fluid that includes a biopolymer or precursor thereof. The loaded drop dispenser is then placed in opposing relation to a surface of a substrate and actuated to deposit a volume of fluid on the substrate. Prior to fluid loading and/or deposition, the drop dispenser is typically adjusted with the axis adjustment elements. The subject invention finds use in a variety of applications.

As summarized above, embodiments of the subject invention provide an adjustment device for fluid deposition devices such as drop dispensers. A drop dispenser adjustment device in accordance with some embodiments has a set of multiple axis adjustment elements or adjusters. Apparatus that comprise an adjustment device together with a drop dispenser may be employed in fluid deposition applications, e.g., in the deposition of biopolymer/biomonomer fluids onto a substrate, e.g., for the production of biopolymeric arrays. A number of approaches have been developed for accurately dispensing small drops of liquid and depositing them onto solid substrates.

The drop dispenser is a non-contact fluid deposition device, which means that fluid drops are ejected to a surface of a substrate without contact between the drop dispenser and the surface. The drop dispenser usually comprises many nozzles or ejectors for dispensing drops of liquid reagents. The number of nozzles in a drop dispenser depends on the diameter of the nozzles and the nozzle pitch and on the drop volume, materials of construction, vendor manufacturing and quality assurance processes, and so forth.

In many embodiments drop dispensers usually comprise one or more chambers, which are filled with liquid to be dispensed. Typically, a chamber has at least one aperture or orifice, usually, one aperture or orifice, which is a micropore or nanopore and through which droplets are dispensed. A micropore is a pore (or aperture or orifice) that is small usually on the order of micrometers (or micron scale) or less. The size of the micropore is usually about 2 μm to about 50 μm, more usually, about 4 μm to about 40 μm. A nanopore is a small pore (or aperture or orifice) on the order of nanometers (i.e., nanometer scale). Materials in a liquid contained within the chamber are moved through the nanopore. The size of the nanopore is usually about 0.5 nm to about 100 nm, more usually, about 1.5 nm to about 30 nm.

The chamber is in fluid communication with a source of liquid, which may be contained in one or more reservoirs that are connected to the chamber by suitable conduits and valves. The drop-dispensing devices also include a means for causing the droplet to be dispensed, for example a piezoelectric driver element or a thermal driver element. The aforementioned devices may also include means for introducing liquids into the devices as well as means for moving materials in the liquids within the devices. The resulting devices can be used to perform a variety of sophisticated chemical and biological analytical techniques.

The drop dispenser may be a head, which may be of a type commonly used in an ink jet type of printer. Each head carries hundreds of ejectors or nozzles to deposit droplets. Each orifice with its associated ejector and a reservoir chamber, acts as a corresponding pulse-jet with the orifice acting as a nozzle.

For example, inkjet printers utilize piezoelectric dispensers to dispense liquid drops at rates of up to at least 2,000 drops per second. In one such system (known as a continuous device) a fluid under pressure issues from an orifice in a dispenser while a piezoelectric crystal attached to the dispenser induces pressure oscillations in the fluid causing the fluid stream to break into drops after issuing from the dispenser. The drops form in the presence of an electrostatic field and thus acquire an electric charge. As the drops continue toward the substrate, they pass through another electrostatic field, which interacts with their acquired charge to deflect them to a desired location.

In another inkjet system fluid from a reservoir is fed into a dispenser and a piezoelectric crystal directly or indirectly coupled to the fluid responds to a voltage pulse to induce a volume change in the dispenser, thus causing a drop of fluid to issue from an orifice toward a substrate. In this type of dispenser (known as a drop-on-demand device) a drop is formed only in response to a predetermined voltage pulse.

In addition to using piezoelectric effects, inkjets may also use heat to form and propel drops of fluid. Thermal inkjets heat a fluid so rapidly that the fluid vaporizes. Rapid volumetric changes provide the impetus for propelling drops of fluid or ink from the dispenser. Bubble jet printers also function on similar principals.

The aforementioned jetting systems have been adapted to dispense liquid reagents to a surface for conducting chemical reactions such as in the analysis of analytes, synthesis of chemical compounds, and the like. For example, in the manufacture of nucleic acid arrays, inkjets can be used to deposit nucleic acids on the substrate surface. See, for example, U.S. Pat. No. 5,658,802. U.S. Pat. No. 5,338,688 describes the use of a bubble-jet for similar applications. The present invention has application in all of the above systems.

The drop dispensers may be part of a drop-dispensing module. The modules are generally a housing or structural element to which the drop dispensers are attached and comprise components for providing liquid communication between the drop dispensers and a source of reagents, which may or may not be part of the module. The drop-dispensing module is a housing structure designed to hold or secure a drop dispenser or an assembly of drop dispensers such that the drop dispenser is held by the drop dispenser adjustment device which in turn in some embodiments is held by a translational arm of a fluid deposition apparatus. The housing is therefore configured to engagingly fit with or connect to a drop dispenser or an assembly thereof. In principle, the housing is configured to fit with any type of drop dispenser assembly, including pulse jet assemblies, such as piezoelectric and thermal pulse jet assemblies.

The overall dimensions of the drop-dispensing module may vary, particularly with respect to the nature of the drop dispenser or an assembly thereof that it is designed to hold. However, in many embodiments, the module is configured to have a length ranging from about 20 to about 200 mm, usually from about 40 to about 100 mm, a height ranging from about 20 to about 100 mm, usually from about 30 to about 80 mm and a width ranging from about 20 to about 100 mm.

The modules may also include reagent sources or manifolds as well as reagent lines that connect the source to fluid dispensing nozzles and the like. The modules may also comprise or be driven by one or more pumps for moving fluid and may also comprise a valve assembly and a manifold. The fluids may be dispensed by any known technique. Any standard pumping technique for pumping fluids may be employed in the dispensing device. For example, pumping may be by means of a peristaltic pump, a pressurized fluid bed, a positive displacement pump, e.g., a syringe pump, and the like.

As mentioned above, embodiments of adjustment devices for adjusting a drop dispenser in accordance with the invention consist of two horizontal axis adjusters, one vertical axis adjuster and two rotational axis adjusters. The adjusters or adjusting elements are integral with a body comprising a base for mounting the device to a drop dispenser. In some embodiments the devices comprise a single rigid frame that holds at least one drop-dispensing module, where in certain embodiments multiple dispensers, e.g., two, three, four, five, six, etc., are held in side-by-side configuration in the single rigid frame of the adjuster. Each housing is adjusted in the frame by a set of axis adjustment elements as mentioned above.

By the phrase “consists of” as used in conjunction with adjusters of the present embodiments means that the device lacks an adjustment in theta about Y. Accordingly, the device may have additional adjusters but not theta about Y.

In the description herein the terms “x-axis,” “y-axis” and “z-axis” and “X,” “Y” and “Z” reference distinct axes and, preferably, a coordinate system that is orthogonal, i.e., a Cartesian coordinate system.

A feature of the drop dispenser adjusters of the subject invention is that each of the one or more drop dispenser modules is adjusted using five axes of adjustment. A set of axis adjustment elements is employed. In many embodiments a set includes at least one horizontal adjustment element and a vertical adjustment element, where the set further includes a rotational axis adjustment element for each horizontal and vertical axis adjustment element of the set except for an adjustment in theta about Y. Often, each set includes two horizontal axis adjustment elements, e.g., an X and Y axis adjustment element; and one vertical axis adjustment element, e.g., a Z axis adjustment element. By axis adjustment element is meant a single component, e.g., a screw component as discussed in greater detail below, or two or more components, e.g., multiple screw elements, that work in combination to move or adjust position in a given axis, e.g., move in the same direction to adjust position.

The drop dispenser adjusters of embodiments of the present invention include at least one drop dispenser module. In some embodiments the drop dispenser adjustment devices include multiple drop dispenser modules. By “multiple drop dispenser modules” is meant a plurality of two or more modules. The total number of modules in many embodiments ranges from 2 to about 10, typically from 2 to about 5 and often from 2 to about 3. When multiple printhead housings are present in the subject printhead adjusters, they are typically configured in a side-by-side manner.

The single rigid frame component of the subject adjustment devices is typically square or rectangular in shape. While the dimensions of the frame may vary significantly, e.g., depending on the number of housings held therein, in many embodiments the frame component has a length ranging from about 30 to about 500 mm, or from about 50 to about 300 mm, or from about 75 to about 200 mm.

As mentioned above, a feature of the drop dispenser adjusters is that each drop dispenser module is adjusted in the frame component of the adjuster by a set of axis adjustment elements. In other words, a plurality of or multiple axis adjustment elements adjust each module in the frame of the adjuster, where the plurality of individual axis adjustment elements is collectively referred to as a set. When the adjuster includes more than one module, each module is adjusted in the frame by its own set of axis adjustment elements. Where multiple drop dispenser modules are present in a given adjuster, and therefore multiple sets of individual axis adjustment elements are present, there is typically an identical number of individual axis adjustment elements in each set. For example, where a representative given adjuster includes two different modules, each module is adjusted in the frame by its own set of five different individual axis adjustment elements, and the total number of individual axis adjustment elements in the adjuster is ten.

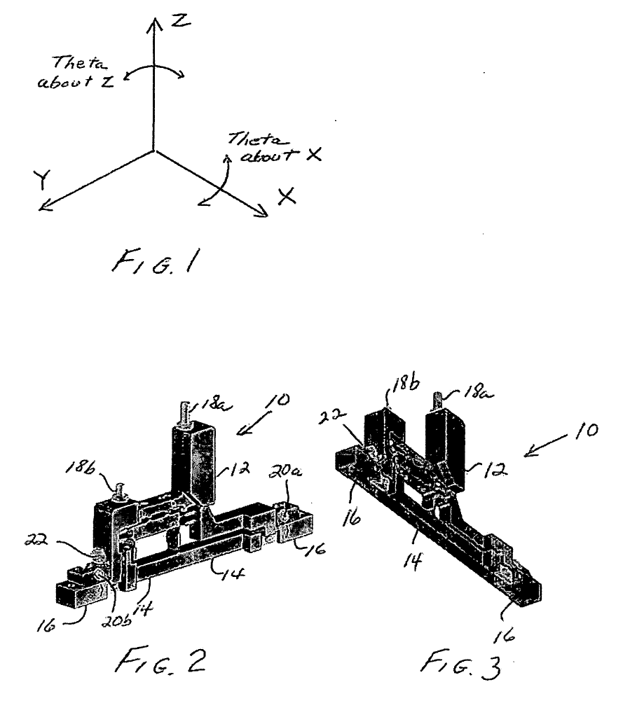

An important feature of the subject invention is that any given set of individual axis adjustment elements, i.e., collection or plurality of individual axis adjustment elements, includes a rotational axis adjustment element for each horizontal and/or vertical axis adjustment element that is present in the set with the exception of theta about Y. For example, where the set includes three horizontal/vertical axis adjustment elements, it also includes a rotational axis adjustment element for X and Z, but not for Y. As such, in this representative embodiment the set includes five different individual axis adjustment elements. In many embodiments, each drop dispenser module is adjusted in the single rigid frame with five different individual axis adjustment elements, made up of three vertical/horizontal axis adjustment elements and two rotational axis adjustment elements corresponding to X and Z. In many embodiments, the five individual axis adjustment elements are: X axis adjustment element; theta about X axis adjustment element; Y axis adjustment element; Z axis adjustment element; and theta about Z axis adjustment element. See, e.g., FIG. 1, which provides an illustration of the different directions for each axis adjustment element in these sets.

In some embodiments the individual adjustment elements are fine pitch screws that thread through a receiving bolt and/or drilled hole through the frame wall and contact a side of the drop-dispensing module held inside the frame. The fine pitch screw of the adjustment element has a pitch that typically ranges from about 56 to about 128, usually from about 80 to about 100 threads/inch. The ball end of the fine pitch screw is threaded through appropriate opening in the frame wall and sits on a hard pad element present on the module. The hard pad element on the module, in many embodiments has sufficient hardness such that it will not dimple. The hardness may be, for example, the hardness as registered on the Mohs scale of at least about 9, usually at least about 7 and more usually at least about 5. The hard pad may be coated with a high contact, force lubrication element, e.g., extreme pressure lube, center point lube, and the like, which provides for reduced friction. In some cases, pads are not necessary, such as, for example, when there is only translation in the axis of the adjuster and no translation caused by any other axis of adjustment.

In many embodiments of the present invention, the bottom surface of the base of the drop dispenser adjustment device is treated to render the surface essentially flat so that the adjuster and the module are essentially vertically aligned with respect to the Y axis and no adjustment for rotation about Y is necessary. By “essentially flat” is meant that the bottom surface is a continuous horizontal, relatively smooth or even surface at least in an area on the bottom surface that contacts the drop dispenser module. The maximum deviation from a horizontal surface is about 0.0025 inches, or about 0.001 inches, or about 0.0005 inches, or about 0.0001 inches, or about 0%, and so forth. By “relatively smooth or even” is meant that a “best fit” plane (3 point contact) defines the mid-plane, and all surface points must lie between two planes, which are parallel to this plane and half the specified dimension to either side of it.

By “essentially vertically aligned” means that the vertical plane of the device and the vertical plane of the Y axis are parallel and, in some embodiments, coplanar or that the vertical plane of the device is non-parallel or non-coplanar with the vertical plane of the Y axis by no more than about 1%, or by no more than about 0.5%, or by no more than about 0.25%, or by no more than about 0.10%, and the like.

The bottom surface of the adjuster may be rendered essentially flat by machining, casting, molding, extrusion, rolling, sanding, grinding, and so forth. Such techniques are well-known in the art.

The individual components of the adjusters or the entire adjustment device may be fabricated from any of a number of materials. Each of the individual components may be fabricated from a separate material or one or more components may be fabricated from the same material. The material for the frame of the adjustment device is dependent on the desired degree of stiffness, modulus of elasticity, thermal expansion coefficient, hardness, resistance to creep, and the like. Such materials include, for example, metals, metal alloys, polymers, plastics such as delrin, polycarbonate, acrylic, etc., resins, silica or silica-based materials, carbon, metal oxides, inorganic glasses, and so forth. Particular metals include, for example, aluminum, aluminum alloys, brass, carbon steel, stainless steel, hastalloy, platinum, gold, silver, titanium, and so forth.

In some embodiments the drop dispenser adjustment device is designed as a one-piece machined flexure that is readily capable of being manufactured. The flexure is conveniently fabricated from an aluminum alloy such as, for example, 7075 aluminum, 6061 aluminum, and the like. The one-piece design provides for a relatively tight pitch between nozzle centers of the drop dispenser, which can be, for example, in some embodiments about 5 to about 50 millimeters (mm) between nozzle centers of the drop dispenser, or in some embodiments about 10 to about 30 millimeters (mm) between nozzle centers of the drop dispenser, or in some embodiments about 15 mm between nozzle centers. With a one-piece flexure design, placement of adjustment screws may be ergonomic, which means that an operator can easily access and manipulate all adjustment devices without affecting adjustment devices on adjacent or nonadjacent adjusters. Furthermore, in some embodiments all adjustment flexures are designed into one plane to achieve critical pitch. This is explained in more detail as follows: Adjustment mechanisms are typically three-dimensional when they have to adjust in three-dimensional space. They tend to be made up of translation and rotational stages that stack in the orientation that they are intended to adjust. This creates a large footprint that requires additional space to access the adjusters from almost each side. By reducing all dimensions of adjustment into essentially one plane, footprint, access space and therefore, pitch, is dramatically reduced. This approach achieves a tight pitch between printheads, which is often required.

Each of the modules may be held in the frames of the adjustment devices by one or more holding elements. These one or more holding elements hold each module in the frame in manner that provides for little if any movement of the module relative to the frame during use, e.g., during fluid deposition. The number of different holding elements per drop-dispensing module in the frame may vary, but typically ranges from about 3 to about 21, usually from about 5 to about 12. In many embodiments, each holding element includes a biasing means such as, for example, a spring or the like, and a turning means such as, for example, a screw or the like, that, in combination, hold the module in the frame and allow adjustment of the module by the adjustment elements relative to the frame without any sliding friction from the spring component of the holding element. In some embodiments the holding elements are substantially frictionless elements. The phrase “substantially frictionless” means there are no components, other than a rounded element such as, e.g., a ball, on the end of the adjustment screw, that come in contact with each other. All motion is accomplished by slight bending of the flexure component of the adjusting device to provide proper alignment of the drop-dispensing module. Over small travel distances, this is essentially true translation that does not require contact and, therefore, has essentially no friction.

Physical stops may be integrated into embodiments of the device to prevent damage either to the device or the printhead from over travel. The stops are either integral to the frame or are a separate piece attached to the device. These stops can be a machined block, a dowel pin, a shoulder screw, and the like.

Specific Embodiments of Devices for Adjusting a Drop Dispenser

In some embodiments a device for adjusting a drop dispenser consists of two horizontal axis adjusters, one vertical axis adjuster and two rotational axis adjusters wherein the adjusters are integral with a body comprising a base for mounting the device to a drop dispenser. In some embodiments the base comprises a machined flat surface for mounting to the drop dispenser. In some embodiments the device is a one-piece flexure. In some embodiments the adjusters are substantially in the same plane. In some embodiments the two rotational axis adjusters are an adjuster for theta about one of the horizontal axis adjusters and an adjuster for theta about the vertical axis adjuster. In some embodiments the adjuster for theta about one of the horizontal axis is an adjuster for theta about an X axis adjuster. In some embodiments the drop dispenser is a piezo printhead.

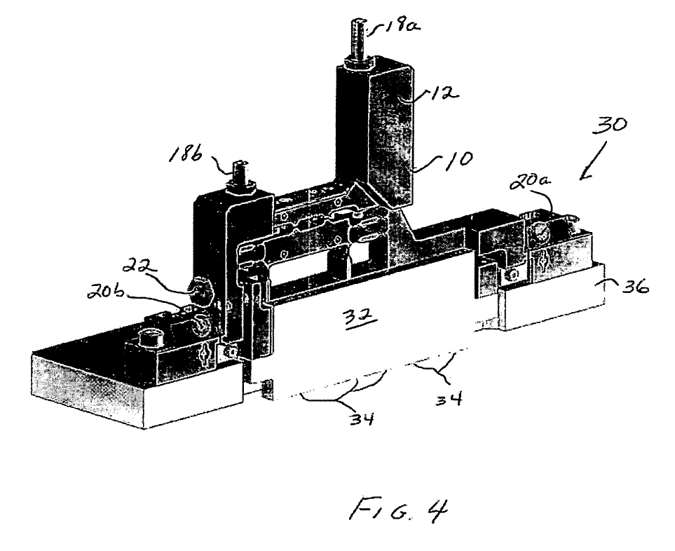

A specific embodiment of an adjustment device in accordance with the present invention is depicted in FIGS. 2 and 3. Device 10 is a one-piece machined flexure having frame 12 with bottom surface 14 for mounting to a drop-dispensing module (not shown in FIGS. 2-3) and bottom surface 16 for mounting to a base (not shown in FIGS. 2-3). Bottom surface 14 is machined flat. Device 10 also comprises two Z adjusting elements 18a and 18b, two X adjusting elements 20a and 20b, and single Y adjusting element 22.

Embodiments of Drop-dispensing Apparatus

Some embodiments of the invention are directed to drop-dispensing apparatus. The apparatus comprise a device for adjusting a drop dispenser, at least one drop dispenser mounted to the device, and a movement arm attached to the device for moving the device with the drop dispenser mounted thereto relative to a surface of a substrate. The device for adjusting a drop dispenser may be embodiments discussed above. In some embodiments the longitudinal plane of the adjustment device and the longitudinal plane of a drop dispenser are substantially co-aligned. In some embodiments the apparatus further comprises a computer for controlling the adjustment device, the drop dispenser and the arm. In some embodiments the drop dispenser is a piezo printhead.

Specific Embodiments of Drop-dispensing Apparatus

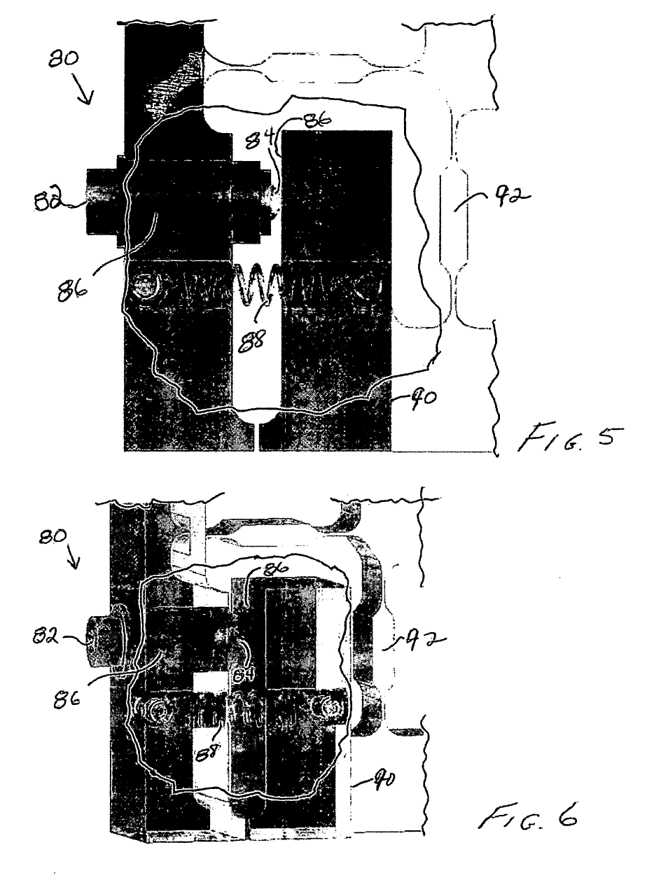

FIG. 4 depicts a drop-dispensing apparatus 30 wherein drop-dispensing module 32 is mounted to device 10 at bottom surface 14. Device 10 is mounted on base 36. Drop-dispensing module 30 is arbitrarily shown with five drop dispensers 34. In addition, in the figure, dispensing apparatus 30 is arbitrarily shown, by way of illustration and not limitation, with a single drop-dispensing module attached.

A cutaway portion of the device of FIGS. 2-4 is shown in FIGS. 5 and 6. An embodiment of an adjusting element 80 is depicted and comprises adjusting screw 82 having a fine pitch thread. The adjusting elements cooperate to hold a drop-dispensing module in the adjustment device and to permit adjustment of the orientation of the drop-dispensing module. Adjusting screw 82 is cooperative with ball 84 such that turning of adjusting screw 82 causes ball 84 to impact wall 86 of the adjusting element. Ball 84 is housed in cylindrical housing 86 and only a portion of ball 84 extends outside the housing. Movement of wall 86 is biased by spring 88. In the embodiment of an adjusting element depicted in FIGS. 5-6, wall 90 is adapted to engage a portion of the drop-dispensing module. Movement of wall 86 causes flexing of flexure portion 92 of the adjustment device of the embodiment shown.

Embodiments of Methods Utilizing a Device for Adjusting Drop Dispensers

Some embodiments of methods for adjusting a drop dispenser relative to another drop dispenser and to a surface of a substrate are discussed herein by way of illustration and not limitation. A drop dispenser such as, e.g., drop dispenser 34 of dispensing module 32 attached to an apparatus 30, is provided that comprises an adjustment device, e.g., device 10, that consists of an X axis adjuster, a theta about X axis adjuster, a Y axis adjuster, a Z axis adjuster and a theta about Z axis adjuster. The adjusters are manipulated to maintain a dispensing orientation of the drop dispenser.

The nature of the dispensing orientation depends on the nature of the drop-dispensing operation. For example, if the above apparatus is employed in the synthesis of an array of biopolymers on the surface of a substrate, the dispensing orientation is chosen to maintain a parallel relationship between the surface of the substrate and the drop dispensers. It is also important to maintain a consistent height above the substrate to minimize the effects of variances in drop velocity and straightness. The angular relation and distance between printheads is another important consideration.

In some embodiments the longitudinal plane of the device and the longitudinal plane of the drop dispenser are substantially co-aligned.

Embodiments of Apparatus for Array Synthesis

Some embodiments of the present invention are directed to apparatus for preparing an array of polymeric compounds on a substrate from multiple polymer subunits. In some embodiments the drop-dispensing apparatus comprises at least one module comprising a drop dispenser mounted to a device for adjusting a drop dispenser as described above.

In some embodiments the apparatus comprise a module moving mechanism adapted to move the drop-dispensing modules relative to a surface of a substrate on a substrate mount to bring each of the drop-dispensing modules into drop-dispensing relationship with the surface. In some embodiments, the apparatus comprises a substrate mount and a substrate moving mechanism adapted to move the substrate to a processing station and back to the substrate mount. In some embodiments the module moving mechanism is adapted to move the drop-dispensing modules relative to a surface of a substrate on a substrate mount to simultaneously bring each of the drop-dispensing modules into drop-dispensing relationship with the surface.

The module moving mechanism is generally an automated device. Such automated devices comprise at least a means for precisely controlling the position of the drop-dispensing module with respect to a substrate surface. Examples of such means include, for example, an XYZ translational mechanism, e.g., an XYZ translational arm to which the module is rigidly fixed. In some embodiments the module moving mechanism also comprises means for firing the head. Such automated devices are well known to those of skill in the printing and document production art and are disclosed in U.S. Pat. Nos. 5,772,829; 5,745,128; 5,736,998; 5,736,995; 5,726,690; 5,714,989; 5,682,188; 5,677,577; 5,642,142; 5,636,441; 5,635,968; 5,635,966; 5,595,785; 5,477,255; 5,434,606; 5,426,458; 5,350,616; 5,341,160; 5,300,958; 5,229,785; 5,187,500; 5,167,776; 5,159,353; 5,122,812; and 4,791,435; the disclosures of which are herein incorporated by reference.

In some embodiments the module moving mechanism is adapted for moving a drop-dispensing module for translation along an x-axis and/or a y-axis and/or a z-axis. This movement may be independent of the movement of the substrate mount along the respective axes, e.g., a y-axis. Translation along an x-axis provides for moving the dispensing device transversely to the direction of movement of the substrate mount (along the y-axis) and in position for dispensing of reagents to the surface of a substrate. In one approach the drop-dispensing module is carried by a stage arrangement, which provides for the desired movement parameters. In this approach the dispensing module is secured to the stage, which is usually attached to a frame member of an apparatus. For example, in one approach the dispensing module may be carried by an orthogonal z-axis stage arrangement attached to an x-axis stage arrangement, which is attached directly to a rigid supporting beam off a base to which the substrate mount is secured. Other approaches for providing the dispensing device with desired movement capabilities may be employed.

To achieve the desired level of dispensing accuracy, the substrate on the substrate mount should be oriented parallel to dispensing device on the y-axis. The positioning of the substrate mount relative to the dispensing device is accomplished in some embodiments using optical systems, which comprise at least one, and in some optical systems, more than one image sensor. Usually, an optical system is employed for positioning the substrate mount along the y-axis as described above. In this instance the optical system usually comprises at least two image sensors. An optical system is employed for positioning the dispensing device along the x-axis. In this instance the optical system usually comprises at least one image sensor. Thus, the optical systems are cooperative to position the dispensing device and the substrate mount relative to one another. Usually, the image sensor is part of a camera.

In some embodiments the components of the apparatus may be mounted on a suitable frame in a manner consistent with the present invention. The frame of the apparatus is generally constructed from a suitable material that gives structural strength to the apparatus so that various moving parts may be employed in conjunction with the apparatus. Such materials for the frame include, for example, metal, lightweight composites, granite and the like.

The apparatus, in some embodiments, may comprise a loading station for loading reagents into the dispensing device and a mechanism for moving the dispensing device and/or the loading station relative to one another. In some embodiments, the apparatus may also comprise a wash station for washing the dispensing device and a mechanism for moving the dispensing device and/or the wash station relative to one another. In some embodiments the apparatus further may comprise a mechanism for inspecting the reagent deposited on the surface of the substrate.

The substrate mount may be any convenient structure on which the substrate may be placed and held for depositing reagents on the surface of the substrate. The substrate mount may be of any size and shape and generally has a shape similar to that of the substrate as long as it is sufficiently able to support the substrate. For example, the substrate mount may be rectangular for a rectangular substrate, circular for a circular substrate and so forth. The substrate mount may be constructed from any material of sufficient strength to physically receive and hold the substrate during the deposition of reagents on the substrate surface as well as to withstand the rigors of movement in one or more directions. Such materials include metals, plastics, composites, and the like.

The substrate may be retained on the substrate mount by gravity, friction, vacuum, and the like. The surface of the substrate mount, on which the substrate is received, may be flat. On the other hand, the surface of the substrate mount may comprise certain structural features such as, for example, parallel upstanding linear ribs, and the like, on which the substrate is placed. Whether the substrate mount is flat or comprises structural features, the resulting surface of the substrate mount on which the substrate rests is planar. The nature and number of structural features is generally determined by the size, weight and shape of the substrate, and so forth. In one embodiment the upper surface of the substrate mount has openings that communicate with a suitable vacuum source to hold the substrate on the substrate mount. The openings may be in the surface of the substrate mount or in structural features on the surface of the substrate mount. In a specific embodiment the substrate mount is a vacuum chuck.

In some embodiments the substrate mount is adapted for movement along certain axes such as, for example, translation along a y-axis and/or for rotation about a center axis that is parallel to a z-axis. Translation along a y-axis provides for moving a substrate on the substrate mount in position for dispensing of reagents to a surface of the substrate. Usually, this requires that the surface of the substrate be parallel to the surface of the dispensing device on which dispensing nozzles are located. Accordingly, the surface of the substrate is normal to the direction in which fluid is dispensed to the surface of the substrate. The ability of the substrate to rotate about a central axis allows any optical system, as discussed below, associated with the substrate mount to provide accurate orientation of the substrate with respect to a dispensing device during the dispensing of reagents to the surface of the substrate.

In one exemplary approach the substrate mount is carried by a stage arrangement, which provides for the desired movement parameters independently of the movement of the dispensing device. In this approach the substrate mount is secured to the stage, which is usually attached to a frame member of the apparatus. For example, the substrate mount may be carried by a stacked Increment-Theta stage arrangement that is attached directly to a granite base. Other approaches for providing the substrate mount with desired movement capabilities may be employed.

In some embodiments the drop-dispensing module is adapted for translation along an x-axis independently of the movement of the substrate mount along the y-axis. Translation along an x-axis provides for moving the drop-dispensing module transversely to the direction of movement of the substrate mount (along the y-axis) and in position for dispensing of reagents to the surface of a substrate. In one approach the drop-dispensing module is carried by a stage arrangement, which provides for the desired movement parameters. In this approach the drop-dispensing module is secured to the stage, which is usually attached to a frame member of the present apparatus. For example, in one approach the drop-dispensing module may be carried by an orthogonal z-axis stage arrangement attached to an x-axis stage arrangement, which is attached directly to a rigid supporting granite beam off a granite base to which the substrate mount is secured. Other approaches for providing the drop-dispensing module with desired movement capabilities may be employed.

In some embodiments to achieve the desired level of dispensing accuracy, the substrate on the substrate mount is oriented parallel to dispensing device on the y-axis. In some embodiments positioning of the substrate mount relative to the dispensing device is accomplished using optical systems, which comprise at least one, and in some optical systems, more than one image sensor. Usually, an optical system is employed for positioning the substrate mount along the y-axis as described above. Usually, the image sensor is part of a camera.

In some embodiments the present apparatus may also comprise a delivery device for delivering the substrate to the substrate mount. The delivery device has the function of receiving or removing a substrate from a substrate supply device and transporting the substrate to the substrate mount. Thus, the delivery device may have any convenient configuration, as long it is able to carry out the above functions. In one embodiment the delivery device is in the form of a two-prong fork where the supporting members (or prongs) of the fork are adapted to receive and carry the substrate. Usually, the prongs are designed to engage the underside surface of the substrate at the perimeter of the substrate. The delivery device may be made of any material that has the structural strength to carry the substrate and withstand the transport functions of the delivery device. Such materials include, for example, metals, lightweight composites, and so forth. The substrate may be retained on the substrate mount by gravity, friction, vacuum, and the like. In one embodiment the upper surface of the substrate mount has openings that communicate with a suitable vacuum source to hold the substrate on the substrate mount. The openings may be in the surface of the substrate mount or in structural features or support members on the surface of the substrate mount.

Another function of the delivery device is to deliver the substrate to the substrate mount so that preliminary adjustments may be made to provide the substrate to the substrate mount in a desired predetermined orientation. In this way the optical system of the substrate mount needs only to fine tune the orientation thereby achieving the desired predetermined orientation of the substrate relative to the dispensing device. To this end, the delivery device has associated therewith a delivery device optical system for positioning the substrate along an x-axis and a y-axis. The optical system may be similar in design to that discussed above for the substrate mount optical system. Thus, the delivery device optical system may comprise at least one image sensor. The delivery device is capable of translation along an x-axis and a y-axis and also is rotatable about a center axis so that the image sensors may communicate to a computer, which in turn may communicate with a mechanism such as a motor and the like that is responsible for the movement of the delivery device, to correct for deviations from the predetermined orientation for the substrate on the delivery device. Other configurations for the delivery device may also be employed.

The apparatus of the invention may also comprise an apparatus for washing certain portions of the dispensers of the drop-dispensing modules such as the inside of the dispensing nozzles and associated chambers and the surface from which the nozzles depend. Washing is generally carried out to remove, from the aforementioned surfaces, residual reagents for synthesizing biopolymers. In one embodiment the washing apparatus or wash station comprises a plurality of receptacles for sealingly engaging each head comprising a plurality of the nozzles having the residual reagents. Once engagement has taken place, appropriate measures are applied such that residual liquid is removed from the nozzles and the nozzles are washed. Normally, the receptacles contain a wash solution and the nozzles are washed by flushing usually under pressure. This procedure involves applying pressure to the wash solution to force the wash solution into the nozzles and applying a vacuum to remove the liquid from the nozzles. Typically, the pressure involved is sufficient to force the wash solution into the nozzles and nozzle chambers without forcing the liquid beyond these points.

In some embodiments the apparatus for washing may comprise a wet wash pad for engaging a surface comprising the nozzles as well as the outer surfaces of the nozzles themselves. The washing apparatus may further comprise a dry pad for engaging the surface comprising the nozzles as well as the nozzles themselves to dry the nozzles and nozzle surface.

In some embodiments the apparatus of the present invention may also comprise a loading station for loading reagents into the dispensers of the drop-dispensing modules. The loading station may be positioned in the present apparatus in a manner similar to that of the wash station. Accordingly, the loading station may be placed in line with the wash station so that it moves transversely with respect to the drop-dispensing module, which moves on the x-axis. The loading station may be of any convenient structure as long as the function of filling the dispensers of the drop-dispensing module with reagents to be dispensed is accomplished. The loading station comprises appropriate controls for controlling the temperature, humidity and the like of the components of the loading station including the reagents contained therein. The loading station also comprises appropriate circuitry and motors for controlling the movement of the loading station parallel to the x-axis. An example of an embodiment of a suitable loading station, by way of illustration and not limitation is described in U.S. Pat. No. 6,689,323, the relevant disclosure of which is incorporated by reference.

In some embodiments the present apparatus may also comprise a mechanism and method for accurately and rapidly observing deposition of droplets of liquid on the surface of a substrate. One such mechanism and method is described in U.S. Pat. No. 6,232,072 B1, issued May 15, 2001 (Fisher). The method includes depositing droplets of fluid carrying a biopolymer or a biomonomer on a front side of a transparent substrate. Light is directed through the substrate from the front side, back through a substrate back side and a first set of deposited droplets on the first side to an image sensor. In this manner, the first set is “imaged”.

As mentioned above, the apparatus and the methods in accordance with the present invention may be automated. To this end the apparatus of the invention further comprises appropriate motors and electrical and mechanical architecture and electrical connections, wiring and devices such as timers, clocks, computers and so forth for operating the various elements of the apparatus. Such architecture is familiar to those skilled in the art and will not be discussed in more detail herein.

To assist in the automation of the present process, the functions and methods may be carried out under computer control, that is, with the aid of a computer and computer program. For example, an IBM® compatible personal computer (PC) may be utilized. The computer is driven by software specific to the methods described herein. Software that may be used to carry out the methods may be, for example, MICROSOFT EXCEL or MICROSOFT ACCESS and the like, suitably extended via user-written functions and templates, and linked when necessary to stand-alone programs that perform other functions.

Another aspect of embodiments of the present invention is a computer program product comprising a computer readable storage medium having a computer program stored thereon which, when loaded into a computer, performs the aforementioned method and/or controls the functions of the aforementioned apparatus.

Specific Embodiments of Apparatus for Array Synthesis

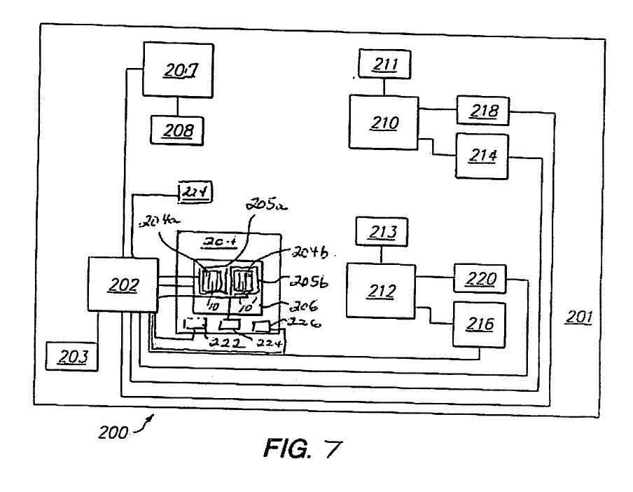

FIG. 7 depicts schematically an apparatus in accordance with embodiments of the present invention. Apparatus 200 comprises platform 201 on which the components of the apparatus are mounted. Apparatus 200 comprises main computer 202, with which various components of the apparatus are in communication. Video display 203 is in communication with computer 202. Apparatus 200 further comprises print chamber 204, which is controlled by main computer 202. The nature of print chamber 204 depends on the number of drop-dispensing modules and the like. Within print chamber 204 are drop-dispensing modules 204a and 204b (each comprising six dispensers, not shown) and module moving mechanism 205a and 205b, which are adapted to move drop-dispensing modules 204a and 204b relative to a surface of a substrate on substrate mount 206 to bring each of the drop-dispensing modules into drop-dispensing relationship with the surface. Drop-dispensing modules 204a and 204b are each respectively affixed to adjustment device 10 and 10′. Transfer robot 207 is also controlled by main computer 202 and comprises a robot arm 208 that moves a substrate to be printed from print chamber 204 to either first flow cell assembly 210 or second flow cell assembly 212. First flow cell assembly 210 is in communication with program logic controller 214, which is controlled by main computer 202, and second flow cell 212 is in communication with program logic controller 216, which is also controlled by main computer 202. First flow cell 210 assembly is in communication with fluid dispensing station 211 and flow sensor and level indicator 218, which are controlled by main computer 202, and second flow cell assembly 212 is in communication with fluid dispensing station 213 and flow sensor and level indicator 220, which are also controlled by main computer 202. Camera 222 is in communication with main computer 202.

Apparatus 200 also comprises loading station 224, which can be of any construction with regions that can retain small volumes of different fluids for loading into dispensers of drop-dispensing modules 204a and 204b. Loading station 224 may comprise a plurality of depots, from which liquids are to be transferred to dispensers of drop-dispensing modules 204a and 204b. Loading station 204 is in fluid communication with dispensing modules 204a and 204b. A motor system (not shown), controlled by computer 202, can be operated to move loading station 224 so that loading station 224 may be moved into position under dispensing modules 204a and 204b to load the dispensers with respective reagent fluids.

Apparatus 200 also comprises wash station 226, which includes a motor assembly (not shown) to move wash station 226 so that wash station 226, controlled by computer 202, can be operated to move wash station 226 into position to flush the dispensers of drop-dispensing modules 204a and 204b. Wash station 226 may also be employed to wash the surfaces of the dispensers and subsequently dry the surfaces of the dispensers.

Apparatus 200 further comprises appropriate electrical and mechanical architecture and electrical connections, wiring and devices such as timers, clocks, and so forth for operating the various elements of the apparatus. Such architecture is familiar to those skilled in the art and will not be discussed in more detail herein.

Embodiments of Array Synthesis

In some embodiments, the present invention provides methods for preparing substrates having an array of features bound to at least one surface of the substrate. The features generally comprise chemical compounds, usually, polymeric chemical compounds, for example, biopolymers, formed from polymer subunits, for example, nucleotide reagents or amino acid reagents.

For example, various ways may be employed to introduce reagents for producing an array of polynucleotides on the surface of a substrate such as a glass substrate. Such methods are known in the art. As mentioned above, one in situ method employs inkjet printing technology to dispense appropriate phosphoramidite reagents and other reagents necessary for forming the polynucleotide onto individual sites on a surface of a substrate. Oligonucleotides are synthesized on a surface of a substrate in situ using phosphoramidite chemistry. Solutions containing nucleotide monomers and other reagents as necessary such as an activator, e.g., tetrazole, are applied to the surface of a substrate by means of, for example, piezo ink-jet technology or thermal ink-jet technology. Individual drops of reagents are applied to reactive areas on the surface using a piezo ink-jet type nozzle or a thermal ink-jet type nozzle. The surface of the substrate may have an alkyl bromide trichlorosilane coating to which is attached polyethylene glycol to provide terminal hydroxyl groups. These hydroxyl groups provide for linking to a terminal primary amine group on a monomeric reagent. Excess of non-reacted chemical on the surface is washed away in a subsequent step.

An in situ method for fabricating a polynucleotide array typically follows, at each of the multiple different locations or addresses at which polymer features are to be formed, the same conventional iterative sequence used in forming polynucleotides from nucleoside reagents on a substrate by means of known chemistry. This iterative sequence can be considered as multiple ones of the following attachment cycle at each feature to be formed: (a) coupling an activated selected nucleoside (a monomeric unit) through a phosphite linkage to a functionalized substrate in the first iteration, or a nucleoside bound to the substrate (i.e. the nucleoside-modified substrate) in subsequent iterations; (b) optionally, blocking unreacted hydroxyl groups on the substrate bound nucleoside (sometimes referenced as “capping”); (c) oxidizing the phosphite linkage of step (a) to form a phosphate linkage; and (d) removing the blocking group (“deblocking”) from the now substrate bound nucleoside coupled in step (a), to generate a reactive site for the next cycle of these steps. In the above method, the coupling can be performed, for example, by depositing drops of an activator and phosphoramidite at the specific desired feature locations for the array. Capping, oxidation and deblocking can be accomplished by treating the entire substrate (“flooding”) with a layer of the appropriate reagent. The functionalized substrate (in the first cycle) or deprotected coupled nucleoside (in subsequent cycles) provides a substrate bound moiety with a linking group for forming the phosphite linkage with a next nucleoside to be coupled in step (a). Final deprotection of nucleoside bases can be accomplished using alkaline conditions such as ammonium hydroxide, in another flooding procedure in a known manner. Consistent with embodiments of the present invention, activator may be dispensed utilizing a dispenser of one of the drop-dispensing modules discussed above.

The foregoing chemistry of the synthesis of polynucleotides is described in detail, for example, in Caruthers, Science 230: 281-285, 1985; Itakura, et al., Ann. Rev. Biochem. 53: 323-356; Hunkapillar, et al., Nature 310: 105-110, 1984; and in “Synthesis of Oligonucleotide Derivatives in Design and Targeted Reaction of Oligonucleotide Derivatives”, CRC Press, Boca Raton, Fla., pages 100 et seq., U.S. Pat. Nos. 4,458,066, 4,500,707, 5,153,319, and 5,869,643, EP 0294196, and elsewhere. The in situ fabrication methods include those described in U.S. Pat. No. 5,449,754 for synthesizing peptide arrays, and in U.S. Pat. No. 6,180,351 and WO 98/41531 and the references cited therein for polynucleotides.

The phrase “polymer forming reagents” includes polymer subunits as well as other reagents necessary for adding the polymer subunit to a growing polymer chain on the surface of a substrate such as activator reagents, and the like. As may be appreciated, the nature of the other reagents depends on the nature of the polymers formed, the polymer forming reagents, and so forth.

A “polymer subunit” is a chemical entity that can be covalently linked to one or more other such entities to form an oligomer or polymer. The polymer subunit may be a monomer or a chain of monomers. Examples of monomers include nucleotides, amino acids, saccharides, peptoids, and the like and chains comprising nucleotides, amino acids, saccharides, peptoids and the like. The chains may comprise all of the same component such as, for example, all of the same nucleotide or amino acid, or the chain may comprise different components such as, for example, different nucleotides or different amino acids. The chains may comprise at least 2, at least 3, at least 4, at least 5, at least 6, at least 7, at least 8, at least 9, at least 10, and so forth, monomer units and may be in the range of about 2 to about 2000, or about 2 to about 200, or about 2 to about 100 monomer units. In general, the polymer subunits, for example, may have first and second sites (e.g., C-termini and N-termini, or 5′ and 3′ sites) suitable for binding of other like monomers by means of standard chemical reactions (e.g., condensation, nucleophilic displacement of a leaving group, or the like), and a diverse element that distinguishes a particular monomer from a different monomer of the same type (e.g., an amino acid side chain, a nucleotide base, etc.). The initial substrate-bound monomer is generally used as a building block in a multi-step synthesis procedure to form a complete polymer, such as in the synthesis of oligonucleotides, polynucleotides, oligopeptides, polypeptides, oligosaccharides, polysaccharides, and the like.

As referred to above, embodiments of the invention have particular application to substrates bearing oligomers or polymers. The oligomer or polymer is a chemical entity that contains a plurality of monomers. It is generally accepted that the term “oligomers” is used to refer to a species of polymers. The terms “oligomer” and “polymer” may be used interchangeably herein. Polymers usually comprise at least two monomers. Oligomers generally comprise about 6 to about 20,000 monomers, preferably, about 10 to about 10,000, more preferably about 15 to about 4,000 monomers. Examples of polymers include polydeoxyribonucleotides, polyribonucleotides, other polynucleotides that are C-glycosides of a purine or pyrimidine base, or other modified polynucleotides, polypeptides, polysaccharides, and other chemical entities that contain repeating units of like chemical structure. Exemplary of oligomers are oligonucleotides and oligopeptides. It is important to note that some skilled in the art classify oligonucleotides as containing less than a specified number of nucleotides such as 100 or less nucleotides and classify polynucleotides as containing more than a specified number of nucleotides such as more than 100 nucleotides. As used herein, the term polynucleotide includes oligonucleotides.

The present methods have particular application to the preparation of arrays comprising biopolymers. Biopolymers are typically found in biological systems and particularly include polysaccharides (such as carbohydrates), and peptides (which term is used to include polypeptides, and proteins whether or not attached to a polysaccharide) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions.

Polynucleotides are compounds or compositions that are polymeric nucleotides or nucleic acid polymers. The polynucleotide may be a natural compound or a synthetic compound. Polynucleotides include oligonucleotides and are comprised of natural nucleotides such as ribonucleotides and deoxyribonucleotides and their derivatives although unnatural nucleotide mimetics such as 2′-modified nucleosides, peptide nucleic acids and oligomeric nucleoside phosphonates are also used. The polynucleotide can have from about 2 to 5,000,000 or more nucleotides. Usually, the oligonucleotides are at least about 2 nucleotides, usually, about 5 to about 100 nucleotides, more usually, about 10 to about 50 nucleotides, and may be about 15 to about 30 nucleotides, in length. Polynucleotides include single or multiple stranded configurations, where one or more of the strands may or may not be completely aligned with another.

A nucleotide refers to a sub-unit of a nucleic acid and has a phosphate group, a 5 carbon sugar ring and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. For example, the term “biopolymer” includes DNA (including cDNA), RNA, oligonucleotides, and PNA and other polynucleotides as described in U.S. Pat. No. 5,948,902 and references cited therein (all of which are incorporated herein by reference), regardless of the source. An “oligonucleotide” generally refers to a nucleotide multimer of about 10 to 100 nucleotides in length, while a “polynucleotide” includes a nucleotide multimer having any number of nucleotides.

Preferred materials for the substrate on which the synthesis takes place are those materials that provide physical support for the chemical compounds that are deposited on the surface or synthesized on the surface in situ from subunits. The materials should be of such a composition that they endure the conditions of a deposition process and/or an in situ synthesis and of any subsequent treatment or handling or processing that may be encountered in the use of the particular array.

Typically, the substrate material is transparent. By “transparent” is meant that the substrate material permits signal from features on the surface of the substrate to pass therethrough without substantial attenuation and also permits any interrogating radiation to pass therethrough without substantial attenuation. By “without substantial attenuation” may include, for example, without a loss of more than 40% or more preferably without a loss of more than 30%, 20% or 10%, of signal. The interrogating radiation and signal may for example be visible, ultraviolet or infrared light. In certain embodiments, such as for example where production of binding pair arrays for use in research and related applications is desired, the materials from which the substrate may be fabricated should ideally exhibit a low level of non-specific binding during hybridization events. However, it should be noted that the nature of the transparency of the substrate is somewhat dependent on the nature of the scanner employed to read the substrate surface. Some scanners work with opaque or reflective substrates.

The materials may be naturally occurring or synthetic or modified naturally occurring. Suitable rigid substrates may include glass, which term is used to include silica, and include, for example, glass such as glass available as Bioglass, and suitable plastics. Should a front array location be used, additional rigid, non-transparent materials may be considered, such as silicon, mirrored surfaces, laminates, ceramics, opaque plastics, such as, for example, polymers such as, e.g., poly (vinyl chloride), polyacrylamide, polyacrylate, polyethylene, polypropylene, poly(4-methylbutene), polystyrene, polymethacrylate, poly(ethylene terephthalate), nylon, poly(vinyl butyrate), etc., either used by themselves or in conjunction with other materials. The surface of the substrate is usually the outer portion of a substrate.

The surface of the material onto which the chemical compounds are deposited or formed may be smooth and/or substantially planar, or have irregularities, such as depressions or elevations. The surface may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethylene amines, polyarylene sulfides, polysiloxanes, polyimides, polyacetates, and the like, where the polymers may be hetero- or homo-polymeric, and may or may not have separate functional moieties attached thereto (for example, conjugated). Various further modifications to the particular embodiments described above are, of course, possible. Accordingly, the present invention is not limited to the particular embodiments described in detail above.

The material used for an array substrate or substrate may take any of a variety of configurations ranging from simple to complex. Usually, the material is substantially rectangular and relatively planar such as, for example, a slide. In many embodiments, the material is shaped generally as a rectangular solid. As mentioned above, multiple arrays of chemical compounds are synthesized on a sheet, which is then singulated, such as, e.g., cut by breaking along score lines, into single array slides. The sheet of material may be of any convenient size depending on the nature of the equipment used, production lot size, production efficiencies, production throughput demands, and so forth. In some embodiments, the sheet of material is usually about 5 to about 13 inches in length and about 5 to about 13 inches in width so that the sheet may be divided into multiple single array substrates having the dimensions indicated below. The thickness of the substrate is about 0.01 mm to 5.0 mm, usually from about 0.1 mm to 2 mm and more usually from about 0.2 to 1. In a specific embodiment by way of illustration and not limitation, a wafer that is 6.25 inches by 6 inches by 1 mm is employed.

The surface of a substrate is normally treated to create a primed or functionalized surface, that is, a surface that is able to substrate the attachment of a fully formed chemical compound or the synthetic steps involved in the production of the chemical compound on the surface of the substrate. Functionalization relates to modification of the surface of a substrate to provide a plurality of functional groups on the substrate surface. By the term “functionalized surface” is meant a substrate surface that has been modified so that a plurality of functional groups are present thereon usually at discrete sites on the surface. The manner of treatment is dependent on the nature of the chemical compound to be synthesized and on the nature of the substrate surface. In one approach a reactive hydrophilic site or reactive hydrophilic group is introduced onto the surface of the substrate. Such hydrophilic moieties can be used as the starting point in a synthetic organic process.

In one embodiment, the surface of the substrate, such as a glass substrate, is siliceous, i.e., the surface comprises silicon oxide groups, either present in the natural state, e.g., glass, silica, silicon with an oxide layer, etc., or introduced by techniques well known in the art. One technique for introducing siloxyl groups onto the surface involves reactive hydrophilic moieties on the surface. These moieties are typically epoxide groups, carboxyl groups, thiol groups, and/or substituted or unsubstituted amino groups as well as a functionality that may be used to introduce such a group such as, for example, an olefin that may be converted to a hydroxyl group by means well known in the art. One approach is disclosed in U.S. Pat. No. 5,474,796 (Brennan), the relevant portions of which are incorporated herein by reference. A siliceous surface may be used to form silyl linkages, i.e., linkages that involve silicon atoms. Usually, the silyl linkage involves a silicon-oxygen bond, a silicon-halogen bond, a silicon-nitrogen bond, or a silicon-carbon bond.

Another method for attachment is described in U.S. Pat. No. 6,219,674 (Fulcrand, et al.). A surface is employed that comprises a linking group consisting of a first portion comprising a hydrocarbon chain, optionally substituted, and a second portion comprising an alkylene oxide or an alkylene imine wherein the alkylene is optionally substituted. One end of the first portion is attached to the surface and one end of the second portion is attached to the other end of the first portion chain by means of an amine or an oxy functionality. The second portion terminates in an amine or a hydroxy functionality. The surface is reacted with the substance to be immobilized under conditions for attachment of the substance to the surface by means of the linking group.

Another method for attachment is described in U.S. Pat. No. 6,258,454 (Lefkowitz, et al.). A solid substrate having hydrophilic moieties on its surface is treated with a derivatizing composition containing a mixture of silanes. A first silane provides the desired reduction in surface energy, while the second silane enables functionalization with molecular moieties of interest, such as small molecules, initial monomers to be used in the solid phase synthesis of oligomers, or intact oligomers. Molecular moieties of interest may be attached through cleavable sites.

A procedure for the derivatization of a metal oxide surface uses an aminoalkyl silane derivative, e.g., trialkoxy 3-aminopropylsilane such as aminopropyltriethoxy silane (APS), 4-aminobutyltrimethoxysilane, 4-aminobutyltriethoxysilane, 2-aminoethyltriethoxysilane, and the like. APS reacts readily with the oxide and/or siloxyl groups on metal and silicon surfaces. APS provides primary amine groups that may be used to carry out the present methods. Such a derivatization procedure is described in EP 0 173 356 B1, the relevant portions of which are incorporated herein by reference. Other methods for treating the surface of a substrate will be suggested to those skilled in the art in view of the teaching herein.

The devices and methods of the present invention are particularly useful for the preparation of individual substrates with an array of biopolymers. An array includes any one-, two- or three-dimensional arrangement of addressable regions bearing a particular biopolymer such as polynucleotides, associated with that region. An array is addressable in that it has multiple regions of different moieties, for example, different polynucleotide sequences, such that a region or feature or spot of the array at a particular predetermined location or address on the array can detect a particular target molecule or class of target molecules although a feature may incidentally detect non-target molecules of that feature.

Normally, the surface of the substrate opposite the surface with the array (opposing surface) does not carry any arrays. The arrays can be designed for testing against any type of sample, whether a trial sample, a reference sample, a combination of the foregoing, or a known mixture of components such as polynucleotides, proteins, polysaccharides and the like (in which case the arrays may be composed of features carrying unknown sequences to be evaluated).

Any of a variety of geometries of arrays on a substrate may be used. As mentioned above, an individual substrate usually contains a single array but in certain circumstances may contain more than one array. Features of the array may be arranged in rectilinear rows and columns. This is particularly attractive for single arrays on a substrate. The configuration of the arrays and their features may be selected according to manufacturing, handling, and use considerations.

Regardless of the geometry of the array on the surface of an individual substrate or on the surface of a sheet comprising a multiple of individual substrates, the arrays normally do not comprise the entire surface of the sheet or of the substrate. For sheets of material comprising a multiple of individual substrates, the sheet typically has a border along its longitudinal edges that is about 0.5 to about 3 mm wide, usually, about 1 to about 2 mm wide. In many embodiments, the border of the individual substrates obtained from the sheet has the same dimensions as the border for the sheet. In some embodiments one area of the individual substrate that is a non-interfeature area or a portion of a border or a combination thereof comprises an identifier such as, e.g., a bar code. It is often desirable to have some type of identification on the array substrate that allows matching a particular array to layout information, since array layout information in some form is used to meaningfully interpret the information obtained from interrogating the array.

As mentioned above, the surface of an individual substrate may have only one array or more than one array. Depending upon intended use, the array may contain multiple spots or features of chemical compounds such as, e.g., biopolymers in the form of polynucleotides or other biopolymer. A typical array on an individual substrate may contain more than ten, more than one hundred, more than five hundred, more than one thousand, more than fifteen hundred, more than two thousand, more than twenty five hundred features, more than 20,000, more than 25,000, more than 30,000, more than 35,000, more than 40,000, more than 50,000, more than 75,000, or more than 100,000 features. In many embodiments the number of features on the individual substrates is in the range of about 100 to about 100,000, about 1000 to about 100,000 and so forth. The features may occupy an area of less than 20 cm² or even less than 10 cm². For example, features may have widths (that is, diameter, for a round spot) in the range from a 10 μm to 1.0 cm. In other embodiments each feature may have a width in the range of 1.0 μm to 1.0 μm, usually 5.0 μm to 500 μm, and more usually 10 μm to 200 μm. Non-round features may have area ranges equivalent to that of circular features with the foregoing width (diameter) ranges.

Each feature, or element, within the molecular array is defined to be a small, regularly shaped region of the surface of the substrate. The features are arranged in a predetermined manner. Each feature of an array usually carries a predetermined chemical compound or mixtures thereof. Each feature within the molecular array may contain a different molecular species, and the molecular species within a given feature may differ from the molecular species within the remaining features of the molecular array. Some or all of the features may be of different compositions. Each array may contain multiple spots or features separated by spaces or areas that have no features. Such interfeature areas are usually present but are not essential. As with the border areas discussed above, these interfeature areas do not carry any chemical compound such as polynucleotide (or other biopolymer of a type of which the features are composed). Interfeature areas typically will be present where arrays are formed by deposition of polymer subunits, as described above. It will be appreciated though that the interfeature areas, when present, could be of various sizes and configurations.

Use of Arrays

Arrays synthesized in accordance with embodiments of the present methods may be utilized in many diagnostic procedures in proteomics, genomics, and so forth.

For example, determining the nucleotide sequences and expression levels of nucleic acids (DNA and RNA) is critical to understanding the function and control of genes and their relationship, for example, to disease discovery and disease management. Analysis of genetic information plays a crucial role in biological experimentation. This has become especially true with regard to studies directed at understanding the fundamental genetic and environmental factors associated with disease and the effects of potential therapeutic agents on the cell. Such a determination permits the early detection of infectious organisms such as bacteria, viruses, etc.; genetic diseases such as sickle cell anemia; and various cancers. This paradigm shift has lead to an increasing need within the life science industries for more sensitive, more accurate and higher-throughput technologies for performing analysis on genetic material obtained from a variety of biological sources.

Unique or misexpressed nucleotide sequences in a polynucleotide can be detected by hybridization with a nucleotide multimer, or oligonucleotide, probe. Hybridization is based on complementary base pairing. When complementary single stranded nucleic acids are incubated together, the complementary base sequences bind to one another or pair to form double stranded hybrid molecules. These techniques rely upon the inherent ability of nucleic acids to form duplexes via hydrogen bonding according to Watson-Crick base-pairing rules. The ability of single stranded deoxyribonucleic acid (ssDNA) or ribonucleic acid (RNA) to form a hydrogen bonded structure with a complementary nucleic acid sequence has been employed as an analytical tool in molecular biology research. An oligonucleotide probe employed in the detection is selected with a nucleotide sequence complementary, usually exactly complementary, to the nucleotide sequence in the target nucleic acid. Following hybridization of the probe with the target nucleic acid, any oligonucleotide probe/nucleic acid hybrids that have formed are typically separated from unhybridized probe. The amount of oligonucleotide probe in either of the two separated media is then tested to provide a qualitative or quantitative measurement of the amount of target nucleic acid originally present.

Direct detection of labeled target nucleic acid hybridized to surface-bound polynucleotide probes is particularly advantageous if the surface contains a mosaic of different probes that are individually localized to discrete, and often known, areas of the surface. Such ordered arrays containing a large number of oligonucleotide probes have been developed as tools for high throughput analyses of genotype and gene expression. Oligonucleotides synthesized on a solid substrate recognize uniquely complementary nucleic acids by hybridization, and arrays can be designed to define specific target sequences, analyze gene expression patterns or identify specific allelic variations. The arrays may be used for conducting cell study, diagnosing disease, identifying gene expression, monitoring drug response, determination of viral load, identifying genetic polymorphisms, analyzing gene expression patterns or identifying specific allelic variations, and the like.

In one approach, cell matter is lysed, to release its DNA as fragments, which are then separated out by electrophoresis or other means, and then tagged with a fluorescent or other label. The resulting DNA mix is exposed to an array of oligonucleotide probes, whereupon selective binding to matching probe sites takes place. The array is then washed and examined or interrogated to determine the extent of hybridization reactions. Arrays of different chemical compounds or moieties or probe species provide methods of highly parallel detection, and hence improved speed and efficiency, in assays. Assuming that the different sequence polynucleotides were correctly deposited in accordance with the predetermined configuration, then the observed binding is indicative of the presence and/or concentration of one or more polynucleotide components of the sample.

Any suitable examining approach may be utilized. The nature of the examining device including a detector for examining the array for the results of one or more chemical reactions is dependent on the nature of the chemical reactions including any label employed for detection, such as fluorescent as mentioned above, chemiluminescent, calorimetric based on an attached enzyme, and the like. As mentioned above, the examining device may be a scanning device involving an imaging system or optical system. Other known examining devices may be employed. Such devices may involve the use of other optical techniques (for example, optical techniques for detecting chemiluminescent or electroluminescent labels) or electrical techniques (where each feature is provided with an electrode to detect hybridization at that feature in a manner disclosed in U.S. Pat. Nos. 6,221,583 and 6,251,685, and elsewhere). Other examining techniques include visual inspection techniques, non-light based methods, and so forth.

The signal referred to above may arise from any moiety that may be incorporated into the sample being analyzed for the purpose of detection. Often, a label is employed, which may be a member of a signal producing system. The label is capable of being detected directly or indirectly. In general, any reporter molecule that is detectable can be a label. Labels include, for example, (i) reporter molecules that can be detected directly by virtue of generating a signal, (ii) specific binding or reacting pair members that may be detected indirectly by subsequent binding or reacting to a cognate that contains a reporter molecule, (iii) mass tags detectable by mass spectrometry, (iv) oligonucleotide primers that can provide a template for amplification or ligation, (v) specific labeled nucleotide monomers which are incorporated into the target samples by enzymatic or chemical incorporation means, and (vi) a specific polynucleotide sequence or recognition sequence that can act as a ligand such as for a repressor protein, wherein in the latter two instances the oligonucleotide primer or repressor protein will have, or be capable of having, a reporter molecule and so forth. The reporter molecule can be a catalyst, such as an enzyme, a polynucleotide coding for a catalyst, promoter, dye, fluorescent molecule, chemiluminescent molecule, coenzyme, enzyme substrate, radioactive group, a small organic molecule, amplifiable polynucleotide sequence, a particle such as latex or carbon particle, metal sol, crystallite, liposome, cell, etc., which may or may not be further labeled with a dye, catalyst or other detectable group, a mass tag that alters the weight of the molecule to which it is conjugated for mass spectrometry purposes, and the like.

The signal may be produced by a signal producing system, which is a system that generates a signal that relates to the presence or amount of a target polynucleotide in a medium. The signal producing system may have one or more components, at least one component being the label. The signal producing system includes all of the reagents required to produce a measurable signal. The signal producing system provides a signal detectable by external means, by use of electromagnetic radiation, desirably by visual examination.

The arrays prepared as described above are particularly suitable for conducting hybridization reactions. Such reactions are carried out on an array comprising a plurality of features relating to the hybridization reactions. The array is exposed to liquid samples and to other reagents for carrying out the hybridization reactions. The substrate surface exposed to the sample is incubated under conditions suitable for hybridization reactions to occur.

After the appropriate period of time of contact between the liquid sample and the array, the contact is discontinued and various processing steps are performed. Following the processing step(s), the array is moved to an examining device as discussed above where the array is interrogated.

Results from the reading may be raw results (such as fluorescence intensity readings for each feature in one or more color channels) or may be processed results such as obtained by rejecting a reading for a feature that is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

When one item is indicated as being “remote” from another, this means that the two items are at least in different buildings and may be at least one mile, ten miles, or at least one hundred miles apart. “Communicating” information references transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data.

All publications and patent applications cited in this specification are herein incorporated by reference as if each individual publication or patent application were specifically and individually indicated to be incorporated by reference, except insofar as they may conflict with those of the present application (in which case the present application prevails). Methods recited herein may be carried out in any order of the recited events, which is logically possible, as well as the recited order of events.

The aforementioned description includes theories and mechanisms by which the invention is thought to work. It should be noted, however, that such proposed theories and mechanisms are not required and the scope of the present invention should not be limited by any particular theory and/or mechanism.

Although the foregoing invention has been described in some detail by way of illustration and example for purposes of clarity of understanding, it will be readily apparent to those of ordinary skill in the art in light of the teachings of this invention that certain changes and modifications may be made thereto without departing from the spirit or scope of the appended claims. Furthermore, the foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description; they are not intended to be exhaustive or to limit the invention to the precise forms disclosed. Many modifications and variations are possible in view of the above teachings. The embodiments were chosen and described in order to explain the principles of the invention and its practical applications and to thereby enable others skilled in the art to utilize the invention.

What is claimed is:

1. A device for adjusting a drop dispenser, the device consisting of two horizontal axis adjusters, one vertical axis adjuster and two rotational axis adjusters wherein the adjusters are integral with a body comprising a base for mounting the device to a drop dispenser.

2. A device according to claim 1 wherein the base comprises a machined flat surface for mounting to the drop dispenser.

3. A device according to claim 1, the device being a one-piece flexure.

4. A device according to claim 1 wherein the adjusters are substantially in the same plane.

5. A device according to claim 1 wherein the two rotational axis adjusters are an adjuster for theta about one of the horizontal axis adjusters and an adjuster for theta about the vertical axis adjuster.

6. A device according to claim 5 wherein the adjuster for theta about one of the horizontal axis is an adjuster for theta about an X axis adjuster.

7. A device according to claim 1 wherein the drop dispenser is a piezo printhead.

8. A drop-dispensing apparatus comprising at least one module comprising a drop dispenser mounted to a device according to claim 1.

9. An apparatus according to claim 8 wherein the longitudinal plane of the device and the longitudinal plane of a drop dispenser are substantially co-aligned.

10. A drop-dispensing apparatus, the apparatus comprising:
(a) a device for adjusting a drop dispenser, the device consisting of two horizontal axis adjusters, one vertical axis adjuster and two rotational axis adjusters wherein the adjusters are integral with a body comprising a base for mounting the device to a drop dispenser, and
(b) at least one drop dispenser mounted to the device.

11. An apparatus according to claim 10 wherein the base comprises a machined flat surface for mounting to the drop dispenser.

12. An apparatus according to claim 10 wherein the device is a one-piece flexure.

13. An apparatus according to claim 10 wherein the adjusters are substantially in the same plane.

14. An apparatus according to claim 10 wherein the two rotational axis adjusters are an adjuster for theta about one of the horizontal axis adjusters and an adjuster for theta about the vertical axis adjuster.

15. An apparatus according to claim 14 wherein the adjuster for theta about one of the horizontal axis is an adjuster for theta about an X axis adjuster.

16. An apparatus according to claim 10 wherein the longitudinal plane of the device and the longitudinal plane of a drop dispenser are substantially co-aligned.

17. An apparatus according to claim 10 further comprising a computer for controlling the device, the drop dispenser and the arm.

18. An apparatus according to claim 10 wherein the drop dispenser is a piezo drop dispenser.

19. An apparatus according to claim 10 further comprising a movement arm attached to the device for moving the device with the drop dispenser mounted thereto relative to a surface of a substrate.

20. A method for adjusting a drop dispenser relative to another drop dispenser and to a surface of a substrate, said method comprising:
(a) providing a drop dispenser attached to an apparatus comprising an adjustment device consisting of an X axis adjuster, a theta about X axis adjuster, a Y axis adjuster, a Z axis adjuster and a theta about Z axis adjuster, and
(b) manipulating the adjusters to maintain a dispensing orientation of the drop dispenser.

21. A method according to claim 20 wherein the adjusters are integral with a body comprising a base for mounting the device to a drop-dispensing module wherein the base comprises a machined flat surface for mounting to the drop-dispensing-module.

22. A method according to claim 20 wherein the device is a one-piece flexure.

23. A method according to claim 20 wherein the adjusters are substantially in the same plane.

24. A method according to claim 20 wherein the longitudinal plane of the device and the longitudinal plane of the drop dispenser are substantially co-aligned.

25. A method according to claim 20 wherein the drop dispenser is a piezo printhead.
